(19) United States
(12) Patent Application Publication
(10) Pub. No.: US 2006/0048569 A1
(43) Pub. Date: Mar. 9, 2006

(54) Probe to detect the level of a liquid particularly water, within a boiler, particularly in a small electric household appliance

(75) Inventors: Arcangelo Manfiotto, Romano D' Ezzelino (IT); Paolo Svaldi, Romano D'Ezzelino (IT)

Correspondence Address: YOUNG & THOMPSON, 745 SOUTH 23RD STREET, 2ND FLOOR, ARLINGTON, VA, 22202, US

(73) Assignee: AXANA 2000 S.R.L, ROMANO D' EZZELINO (VI) (IT)

(21) Appl. No.: 10/523,024

(22) PCT Filed: Jul. 22, 2003
(86) PCT No.: PCT/IT03/00451

§ 371 Date: Feb. 2, 2005

(30) Foreign Application Priority Data
Aug. 2, 2002 (IT) RM2002A000415

(51) Int. Cl. G01F 23/24

(52) U.S. Cl. 73/304 R

(57) ABSTRACT

The invention relates to a probe (1) to detect the level of a liquid. particularly water, within a boiler (10), particularly in a small electric household appliance, comprising a probe plug (2), provided at the bottom with a joint (5) for coupling with the boiler body (10), a metallic disc element (7) for the electric contact, a metallic spring (6), provided on said probe plug (2), and in contact with said metallic disc (7), and the upper part of which contacts said spring, and means (11) for supplying said probe and/or transmitting the signal to an electric board, coupled with said metallic disc (7).

The present invention relates to a probe to detect the level of a liquid, particularly water, within a boiler, particularly in a small electric household appliance.

More specifically, the invention concerns a probe of the above kind able to allow to precisely determine the level of the liquid present within the boiler.

As it is well known, different kind of vapour generators exist, to be applied on small electric household appliance. They can be roughly divided into two classes:
1) closed pressure boiler;
2) continues recharge pressure boiler.

The first type of boiler provides a boiler element, usually comprised of stainless steel or aluminium, an inner or outer resistance, to heat the liquid (water), a pressure switch for measuring the pressure within the boiler and connected with the resistance power supply or at the moment of the measure of the wished pressure disconnects the supply to the current, and other safety components such as thermostats and safety cap, and finally systems to determine the exhaustion of the water within the boiler, such as a bulb thermostat.

As to the continuos recharge pressure boiler, giving the best performances, provide a boiler, usually comprised of stainless steel or aluminium, an inner or outer resistance, to heat the liquid (water), a pressure switch for measuring the pressure within the boiler and connected with the resistance power supply, other safety components such as thermostats and safety valve, and finally a system to determine the level of the water into the boiler by a probe controlled by an electronic board. Discharge of water coming from a cold water reservoir occurs thanks to a pump operated when the probe detects that the water level within the boiler is lowered.

Furthermore, other continuous recharge systems exist giving not satisfying results in terms of vapour quality.

At present, control of water level in a boiler is based on the principle of the ionic conductivity of water: probe, supplied at low tension, when laps the water, causes the passage of a little current, that is perceived and processed by the electronic board.

The probe, insulated by a Teflon® joint with respect to all the others components that can be in contact with the boiler, must be fed by an electronic board.

Connection for the signal transmission between the probe and the board usually is realised by a direct outer contact through an electric wire.

This kind of solution is characterised by the drawback that an outer wire is always present, which is subjected to wearing. Furthermore, it can be accidentally disconnected since placed outside, and thus the connection can be lost. To solve this drawback, it can be hidden in a suitable seat protected by a cover.

It is further possible that, being it necessary to intervene for routine maintenance reasons, it is necessary to remove the probe and when it is put again in its original position, the operator forgets to connect it with the wire or insert it in a wrong way, thus causing the malfunction of the system.

In order to overcome these drawbacks, it is suggested the solution according to the present invention, providing a probe connected with the electronic board by an indirect coupling.

It is therefore specific object of the present invention a probe to detect the level of a liquid, particularly water, within a boiler, particularly in a small electric household, comprising a probe plug, provided at the bottom with a joint for coupling with the boiler body, a metallic disc element for the electric contact, a metallic spring, provided on said probe plug, and in contact with said metallic disc, and the upper part of which contacts said spring, and means for supplying said probe and/or transmitting the signal to an electric board, coupled with said metallic disc.

Preferably, according to the invention, said joint is comprised of Teflon®.

Still according to the invention, said metallic disc is coupled with the probe plug by screws or rivets, or by overprinting.

Always according to the invention, said spring is a substantially U-shaped spring. Straddled on the probe plug, possibly housed in a suitable seat, and having foot contacting said metallic disc.

Furthermore, according to the invention, it is provided a metallic contact, preferably a spring, exiting from the housing of the boiler and contacting with said metallic disc.

The present invention will be now described, for illustrative but not limitative purposes, according to its preferred embodiments, with particular reference to the figures of the enclosed drawings, wherein:

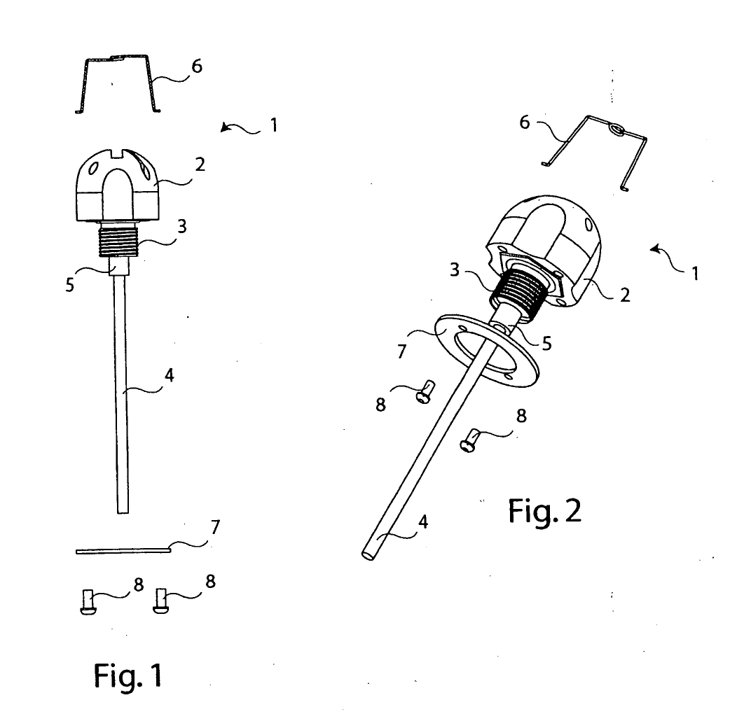

FIG. 1 is a perspective exploded view of a probe according to the invention;

FIG. 2 is an exploded front-view of the probe of FIG. 1;

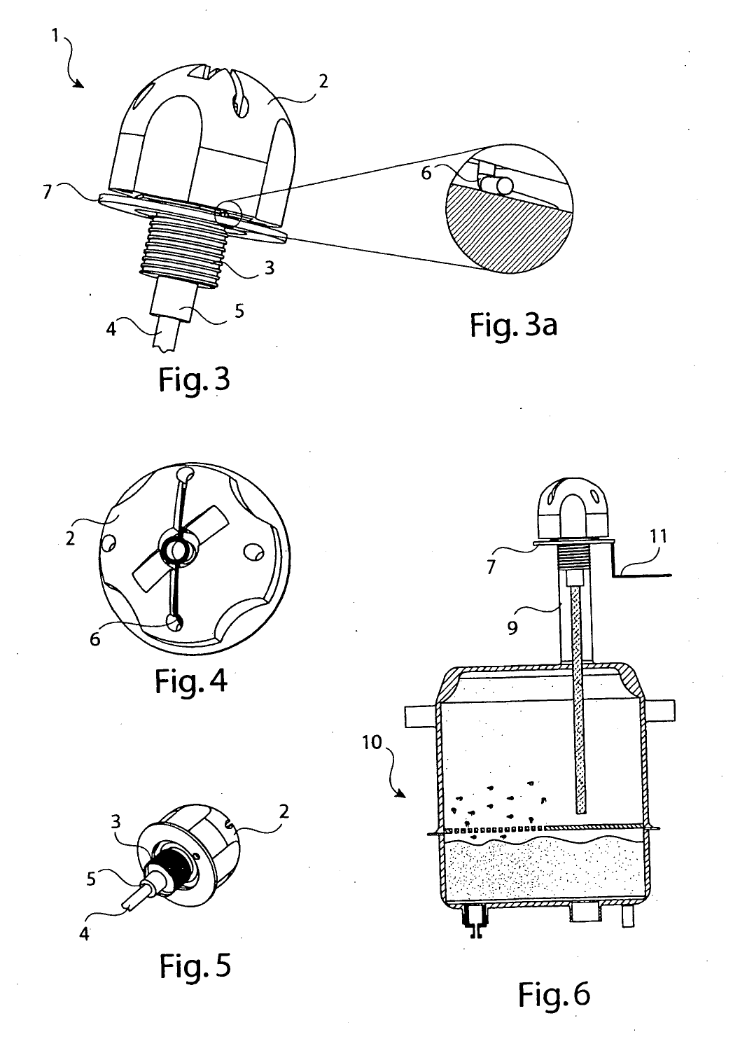

FIG. 3 is a perspective view of the plug of the probe according to the invention;

FIG. 3a shows a particular of the plug of FIG. 3;

FIG. 3 is a top view of the plug of the FIG. 3;

FIG. 5 is a perspective rear view of the plug of FIG. 3; and

FIG. 6 schematically shows a boiler provided with a probe according to the invention.

Observing first FIGS. 1-5 of the enclosed drawings, it is shown a probe according to the invention, generically indicated, by the reference number 1, providing a plug probe 2, a probe body 3, a probe 4, a Teflon® joint 5, a spring 6, a conductive disc 7, and screws or rivets 8 for anchoring to the conductive tube 9 (that can be seen in FIG. 6).

Usually, as it can be noted from FIG. 6, a continuous recharge vapour generator is usually comprised of a boiler 10, a resistance. for heating water, a pump for supplying water into the boiler 10, a probe 4 aiming to read the water level present within the boiler 10, an electronic board (not shown) processing the data provided by the probe 4 and controlling the phases of the vapour generation process.

In the solution suggested according to the present invention, connection between the probe 4 and the board occurs by an indirect contact, so that a conductive object 11 is supplied, that supplies the probe 4.

The probe according to the present invention is supplied by the steel disc 7 anchored to the insulating plug 2 of the probe 1, that is contacted with a spring 6 lapping the end of the probe 1.

The system operates properly if, during the operation of the boiler 10, the passage of a clear signal is guaranteed through the probe 4, without noise signals that could jeopardise the proper operation of the system.

The above result is obtained if good contacts between the conductive parts of the probe are ensured.

By the solution according to the present invention a good contact is obtained by the fact that the disc 7, lapping the “foot” of the spring 6 is tightened on the probe plug 2 by the rivets 8, and by the fact that the end of the probe is fixed to the spring. Contact is further ensured when the probe 4 is inserted in the proper seat of the boiler 10.

In fact, when it is screwed, it exerts a further pressure on the disc 7, and consequently on the spring 6-disc 7 contact.

By this solution, the user can unscrew the probe plug 2 as wished without the preoccupation of acting on the probe 4 to disactivate/activate the electric contact.

To prevent that turbulences of the vapour within the boiler 10 do not create noise signals (false signals), a Teflon® joint 3 close to the probe plug 2, where, due to the water film, electric jumpers could be formed between the part under tension of the probe 1 and the part in contact with the ground boiler 10.

The present invention has been described for illustrative but not limitative purposes, according to its preferred embodiments, but it is to be understood that modifications and/or changes can be introduced by those skilled in the art without departing from the relevant scope as defined in the enclosed claims.

1. Probe to detect the level of a liquid, particularly water, within a boiler, particularly in a small electric household appliance, characterised in that it comprises a probe plug, provided at the bottom with a joint for coupling with the boiler body, a metallic disc element for the electric contact, a metallic spring, provided on said probe plug, and in contact with said metallic disc, and the upper part of which contacts said spring, and means for supplying said probe and/or transmitting the signal to an electric board, coupled with said metallic disc.

2. Probe according to claim 1, characterised in that said joint is comprised of Teflon®.

3. Probe according to claim 1, characterised in that said metallic disc is coupled with the probe plug by screws or rivets, or by overprinting.

4. Probe according to one of the claim 1, characterised in that said spring is a substantially U-shaped spring. Straddled on the probe plug, possibly housed in a suitable seat, and having foot contacting said metallic disc.

5. Probe according to claim 1, characterised in that it is provided a metallic contact, preferably a spring, exiting from the housing of the boiler and contacting with said metallic disc.

6. (canceled)
